(19) United States
(12) Patent Application Publication
(10) Pub. No.: US 2017/0232753 A1
(43) Pub. Date: Aug. 17, 2017

(54) Container for Storing and Dispensing a Liquid

(71) Applicant: Sellenis Limited, Melbourn (GB)

(72) Inventors: Matthew Tomlin, Melbourn (GB); Ian Fost, Melbourn (GB)

(73) Assignee: Sellenis Limited, Melbourn (GB)

(21) Appl. No.: 15/502,421

(22) PCT Filed: Aug. 19, 2015
(86) PCT No.: PCT/GB2015/052416

§ 371 Date: Feb. 7, 2017

(30) Foreign Application Priority Data
Aug. 14, 2014 (GB) 1414399.4

(51) Int. Cl. B41J 2/175

(52) U.S. Cl. CPC B41J 2/17513; B41J 2/17559; B41J 2/17556

(57) ABSTRACT

A container (2) for storing and dispensing a liquid comprises a chamber for holding a liquid, the chamber being defined by rigid chamber walls (4); a liquid outlet port (10) for dispensing the liquid from the chamber; and a gas port (20) configured to allow air into the chamber from the atmosphere outside the chamber only when the pressure outside the chamber exceeds the pressure inside the chamber by more than a predetermined threshold. When liquid is dispensed from the container via its outlet port, the pressure within the chamber will be reduced. When the pressure within the chamber falls below the external, ambient pressure by more than a predetermined amount, the gas port will open to allow air into the chamber from the atmosphere. This allows liquid to continue to be withdrawn readily from the container, by preventing a significant pressure differential from building up between the inside and outside of the chamber.

### FIELD OF THE INVENTION

The present invention relates to a container for storing and dispensing a liquid. More particularly, it concerns such containers for use in printers such as inkjet printers.

### BACKGROUND TO THE INVENTION

Printers such as inkjet printers often use replaceable ink cartridges to provide a supply of ink. Also, a replaceable solvent cartridge may be used to provide solvent to add to the ink to maintain a suitable viscosity. The present invention is directed at a container for use as an ink or a solvent cartridge in an inkjet printer. The container may also be suitable for use in other applications where replaceable liquid containers are used, such as air-fresheners and paint dispensers.

### SUMMARY OF THE INVENTION

The present invention provides a container for storing and dispensing a liquid, comprising:
a chamber for holding a liquid, the chamber being defined by rigid chamber walls;
a liquid outlet port for dispensing the liquid from the chamber; and
a gas port configured to allow air into the chamber from the atmosphere outside the chamber only when the pressure outside the chamber exceeds the pressure inside the chamber by more than a predetermined threshold.

When liquid is dispensed from the container via its outlet port, the pressure within the chamber will be reduced. When the pressure within the chamber falls below the external, ambient pressure by more than a predetermined amount, the gas port will open to allow air into the chamber from the atmosphere. This allows liquid to continue to be withdrawn readily from the container, by preventing a significant pressure differential from building up between the inside and outside of the chamber. At the same time, the gas port does not allow liquid to flow out of the chamber, thereby avoiding any leakage of the liquid.

Preferably, the gas port comprises a non-return valve having a valve body. The valve body may be formed of an ethylene propylene diene monomer (EPDM) rubber material or a perfluoroelastomer material, such as Kalrez (Registered Trade Mark) for example. Where the container is intended for use in a printer, the valve body is preferably formed of a material which is resistant to inorganic solvents such as methyle ethyl ketone (MEK), acetone and ethanol.

The material used to form the valve body may be selected to resist shrinkage in use caused by the action of liquids it is likely to come into contact with. For example, some solvents (particularly MEK, acetone and ethanol) tend to leech out filler materials used in rubber and over time this will reduce its mass. The material (and in particular embodiments, the grade of EPDM rubber) used is chosen such that the shrinkage over its typical lifetime is less than a 5% reduction in weight. Preferably, the weight loss is less than 4%.

In preferred embodiments, the non-return valve is a duckbill valve. This configuration has been found to be cost effective and suitable for mounting in a chamber port.

The valve body may be mounted in an opening defined within the gas port, with the opening and valve body configured such that the valve body is radially compressed by the opening.

The valve may include a radial flange which extends outwardly from the valve body, over an outer surface surrounding the opening. The flange may be integrally formed with the valve body. The gas port may further include a clamp ring which, in the assembled container, axially compresses at least a portion of the flange against the outer surrounding surface to ensure a sufficiently fluid-tight seal is formed between the valve flange and the opening.

The axial width of the flange in its compressed state may be defined by the clamp ring configuration. In preferred embodiments, the body of the clamp ring engages the flange to compress it. A peripheral portion of the ring extends axially over the flange from the body of the clamp ring and contacts the surface of the port surrounding the port opening in which the valve body has been inserted. It therefore defines a stop which indicates during assembly that the clamp ring has been inserted to the required extent into the valve body. Preferably, the projecting peripheral portion is radially spaced from the outer circumference of the flange (in its uncompressed state, and preferably also its compressed state) to ensure the flange is able to expand radially when it is compressed.

The clamp ring has a central channel through it which defines a fluid path coupled to the fluid path through the valve.

The clamp ring may include a projection which is received by the valve body and radially outwardly compresses at least a portion of the valve body against an inner wall of the opening in the assembled container. This ensures a sufficiently fluid-tight seal is formed between the outer circumference of the valve body and the inner wall of the opening. It also securely retains the valve body and clamp ring in the gas port.

The projection may have cylindrical inner and outer surfaces. The inner cylindrical surface defines part of the fluid path through the clamp ring, and the outer cylindrical surface engages the valve body and compresses it against the port opening.

The clamp ring is preferably press-fitted into the valve body. In the assembled container, they may be held in place by frictional forces alone.

The dimensions of the opening, the valve body and the clamp ring are preferably selected such that the radial compression of the valve body by the clamp ring is greater than the axial compression of the valve flange by the clamp ring. The clamp ring may be formed of a plastic material or metal. It is preferably relatively rigid in comparison to the valve body. The clamp ring material should be compatible with and resistant to corrosion or degradation by the liquids it is likely to come into contact with in use. In an ink cartridge application, it is likely to need to be resistant to MEK, acetone and ethanol.

In further preferred embodiments, the gas port is configured to allow gas to flow out of the chamber when the pressure within the chamber exceeds the pressure of the atmosphere surrounding the chamber by a predetermined threshold. This allows excess internal pressure within the chamber to be vented to its exterior, and ensures that the pressure within the container remains within desired limits during operation. As a result, the amount of liquid withdrawn from the container by a given printer ink system is substantially consistent over a range of conditions. This assists the printer in maintaining the required ink viscosity. Significant pressure increases within the cartridge (as a result of temperature increases for example) would otherwise lead to requiring significant solvent additions to the ink within the printer to maintain the desired viscosity.

Preferably, the gas port includes a pressure relief valve which is integrally formed with the non-return valve body. The pressure relief valve may be an umbrella valve, for example.

The container is particularly suitable for use in a Continuous Ink Jet (CIJ) system. In this system, a stream of drops (in the form of a jet) continuously emanates from, normally, a single nozzle under pressure. Only a small percentage of the droplets in this stream are selected for printing and then are deflected to the substrate to be printed. The drops that are not selected for printing continue their flightpath to a gutter and are then sucked back to the ink supply tank through a small plastic pipe. The ink supply is normally remote from the printhead by 3 to 6 m. The present container or cartridge may be suitable for storing and replenishing ink and solvent or “make up” in a CIJ ink supply subsystem. A CIJ printer supplies ink to the printhead at a typical 45 psi pressure to be able to generate the continuous stream of droplets.

Inks for use with CIJ systems are mostly (in excess of 95%) composed of volatile solvents such as MEK, acetone and methanol. The solvents in a CIJ ink are present in excess of 80% per volume of the ink. As the ink stream is continuously running and coming into contact with atmospheric air, these solvents evaporate, the ink composition changes and the ink viscosity as a result increases. For this purpose, it is a prerequisite in CIJ printers that an automatic ink viscosity control system that continuously measures and adjusts the ink viscosity is implemented in the printer for its reliable continuous industrial operation. This viscosity control would need to be able to measure the viscosity and adjust it automatically by replenishing the lost solvent and used ink. In existing procedures, replenishment of lost solvent and used ink is carried out by pouring ink or solvent from bottles into the ink supply tank. This is not only labour intensive, it also poses a serious health and safety problem to the operators and to the factory too. This is because there is a high risk of spillage that could lead to a fire. Pouring ink and solvent also leads to the release of harmful solvent vapour close to the operator replenishing the tank. The solvent vapour, if not properly extracted (ventilated), can affect the whole factory too. Furthermore, there is a risk that an operator may overfill the ink supply tank or pour the wrong replenishing solvent or ink and mix these with incompatible ink in the supply tank. Attempts at other replenishing methods have also failed to eliminate these health, safety and operational problems.

The present disclosure addresses these problems by providing removable, replaceable ink or solvent cartridges. When the cartridge is not being used it may be sealed; on one side by the septum and on the other side by the combination valve. When in operation and assembled in the printer, a replenishing tube is automatically inserted into the container through the compliant, re-sealable part of the septum which hermetically creates a seal around the tube. This tube is in direct communication with the ink supply tank via a vacuum pump and an electromagnetically operated solenoid valve. When the vacuum pump is running and the electromagnetic valve is operated to its open position, its draws ink or solvent from either of the ink or solvent cartridges. Since the cartridge walls are solid and not collapsible, a combination valve may be provided. This may open whenever the electromagnetic valve is opened and vacuum is created inside the cartridge to allow air in so that ink can flow through the tube in the septum and through the opened electromagnetic solenoid valve.

The combination valve may also be designed in such a way that when there is a positive pressure inside the cartridge, ink is not allowed to leak through the valve to the outside of the cartridge but air is allowed to escape. This is particularly important during manufacturing when the cartridges are being filled with ink or solvent as the septum opening may not be large enough to allow the fitting of the filling tube whilst leaving space for air to escape from inside the cartridge to allow the filling of the cartridge. It may compensate for environmental changes such as increases in temperature.

Furthermore, the combination valve may allow ink or solvent to be safely pumped back into an empty cartridge during instances where the ink in the main ink supply tank of the printer needs to be drained. This may happen when the printer is required to run a different type of ink or solvent or when the printer is being de-commissioned. The present cartridge construction and the combination valve may allow such a procedure to occur safely. The ink pumped back into the empty cartridge can then either be stored for later re-use or disposed of safely as and when required.

Operational errors may also be avoided by fitting the cartridge with a memory chip (a “smart chip”) containing ink or solvent identifiers amongst other information. The memory chip, when assembled into the printer, abuts against a chip reader to allow the printer CPU to automatically read and compare the type of ink or solvents in the cartridges to those already in the printer. If these do not match, the printer software may alert the operator, for example via a user interface screen. It may also prevent the replenishing electromagnetic valve from opening, ensuring incompatible ink or solvent are not mixed.

A removable and replaceable ink or solvent supply cartridge of this disclosure may use unitary/single combination valve and single air flow path to overcome the longstanding problems noted above with replenishing ink or solvent in a CIJ printing system.

### BRIEF DESCRIPTION OF THE DRAWINGS

Embodiments of the invention will now be described by way of example and with reference to the accompanying schematic drawings, wherein:

FIG. 1 is a rear perspective view of a container embodying the invention;

FIG. 2 is a perspective front view of the container of FIG. 1;

FIG. 3 is a side view of the container of FIG. 1;

FIG. 4 is a rear view of the container of FIG. 1;

FIG. 5 is a partial cross-sectional view of the gas port of the container of FIG. 1;

FIG. 6 is a perspective view of the duckbill valve shown in FIG. 5; and

FIG. 7 is a partial cross-sectional view of a different gas port configuration according to the invention for use in the container of FIG. 1.

### DETAILED DESCRIPTION OF THE DRAWINGS

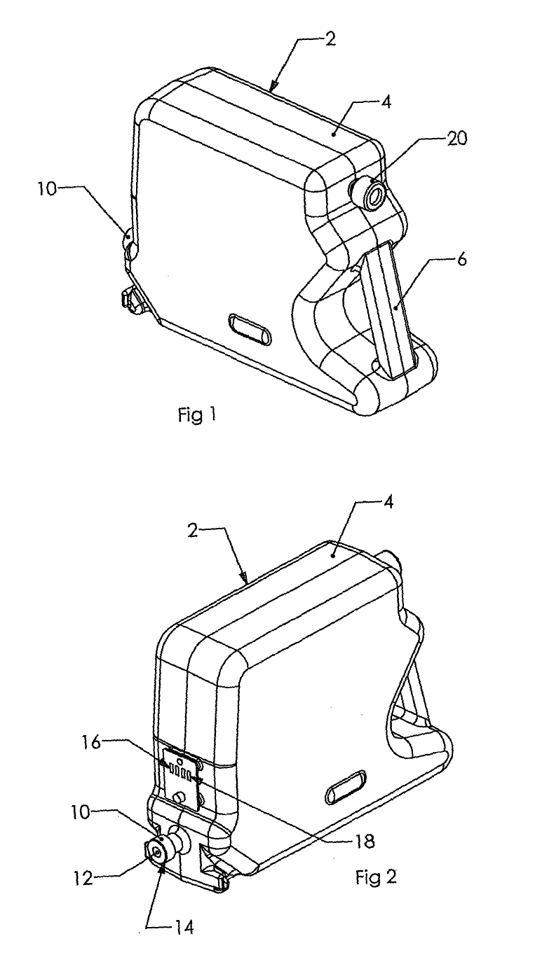

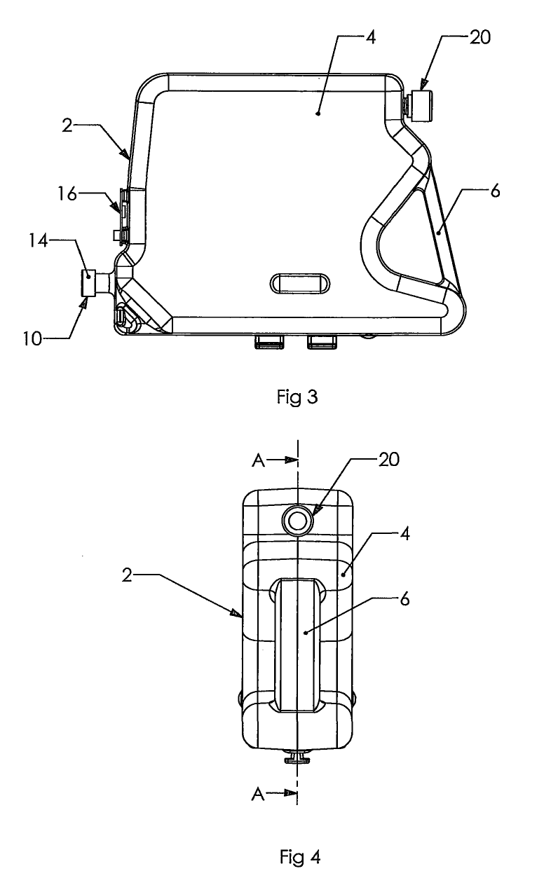

A container according to an embodiment of the invention is depicted in FIGS. 1 to 4. It is in the form of a replaceable cartridge 2 for an inkjet printer. It has a rigid body 4 which defines a chamber inside for holding a liquid. The chamber walls provided by the body are formed of a rigid material. The body includes a handle 6 at its rear to be grasped by a user when inserting the cartridge into a printer.

The rigid body is formed using a blow-moulding process. It may have a wall thickness in the range 0.8 mm to 2.25 mm, and preferably around 2 mm. It is formed of a thermoplastic material such as high-density polyethylene (HDPE), for example. The HDPE material may be fluorinated internally to increase its resistance to corrosive liquids.

The container includes a liquid outlet port 10 through which liquid may be dispensed from the container. As is the case in known ink cartridges, the liquid outlet port is closed by means of a septum formed of rubber or PTFE (polytetrafluoroethylene) for example. Preferably, the septum is formed of a rubber layer with an inner sealing face formed of PTFE which is resistant to solvents used in ink. When the container is inserted into a printer, the septum is pierced by a hollow needle via which ink is then extracted. The septum re-seals when the container is removed from the printer and the needle removed. The septum 12 is held in place by a crimped cap 14.

An electronic device 16 is located on the outside of the body 4 above the liquid outlet port 10. This is provided with electrical contacts 18 to enable the cartridge to communicate and interact electronically with a printer it is installed into.

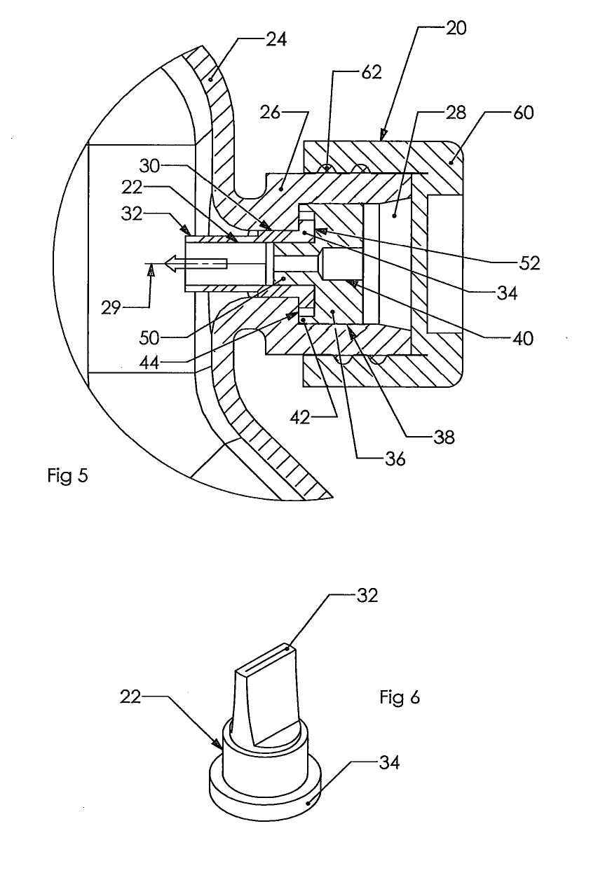

The container also includes a gas port 20. A cross-sectional view of the gas port along the line A-A marked on FIG. 4 is shown in FIG. 5.

The gas port 20 includes a non-return valve. In the embodiment of FIG. 5, this valve is in the form of a “duckbill” valve. This comprises a duckbill valve body 22. A perspective view of the valve is shown in FIG. 6.

The rear wall 24 of the container rigid body 4 is shaped to form an outwardly extending conduit 26. Conduit 26 defines a channel 28 therethrough, which extends from the interior of the chamber to its exterior and the surrounding atmosphere. Channel 28 has a central axis 29. A portion of the channel defines a cylindrical opening 30, which receives and engages with a portion of the valve body 22.

One end 32 of the valve body extends inwardly away from the opening. The other end of the valve body extends outwardly away from the opening 30 in the axial direction, and radially outwardly to form a flange 34.

A clamp ring 36 is received by a cylindrical portion 38 of the channel 28, which has a greater diameter than the opening 30. An axial duct 40 extends through the clamp ring. A circumferential rim 42 extends axially inwardly from the body of the clamp ring. It engages a transverse, radially extending surface 44 of the conduit 26, which surrounds the opening 30.

The clamp ring also includes a projection 50 which extends axially inwardly from the body of the clamp ring. The duct 40 extends through the centre of the projection. The projection is received by the valve body 22.

A removable cap 60 closes the outer open end of the channel 28 extending through the conduit 26. A thread 62 is defined by an outer circumferential surface of the conduit 62. A complementary thread is defined on an inwardly facing surface of the cap 60 so that the cap can be removably engaged with the conduit using the screw threads.

This cap ensures that no fluid can escape from the interior of the chamber during transport or storage, to satisfy relevant regulations governing any hazardous materials such as ink solvents which may be carried in the container. The cap is unscrewed prior to use of the container in the printer.

During assembly of the container, the valve body 22 is inserted into the opening 30. They are preferably dimensioned to produce a radial compression of around 20% of the portion of the valve body in engagement with the opening (that is, a reduction of its volume by around 20%).

The clamp ring is then pressed into position, with the clamp ring body received by the channel section 38 of the conduit 26 and the clamp ring projection 50 received by the valve body 22. A transverse surface 52 of the clamp ring engages the flange 34 of the valve body. Insertion of the clamp ring leads to axial compression of the flange. The extent of this compression is determined by the axial extent of the clamp ring rim 42.

The projection 50, the valve body 22 and the opening 30 are dimensioned such that there is radial compression of the valve body between the clamp ring and the opening 30.

The component parts are dimensioned such that the axial compression of the flange 34 is slightly greater than the radial compression of the valve body. Preferably, either or both of the radial and axial compressions are greater than the respective typical compressions specified for normal use of a given duckbill valve.

For example, the duckbill valve may be specified to have a radial compression of 13% and an axial compression of 3%. In a preferred embodiment, the radial compression is greater than 18 and less than 30% and the axial compression is greater than 5 and less than 10%.

As noted above, liquids in contact with the valve in use may cause shrinkage of the valve material. To ensure that the valve provides a reliable seal despite any weight or volume reduction associated with this effect, the valve is preferably housed with greater radial and axial compression than would normally be the case.

The duckbill is selected to open when fluid is required by the printer. This threshold may be for example when the pressure in the printer needle is 30 mBar (3,000 Pa) below the ambient pressure outside the chamber (that is, the valve opens when the pressure differential across the valve is at or exceeds this amount).

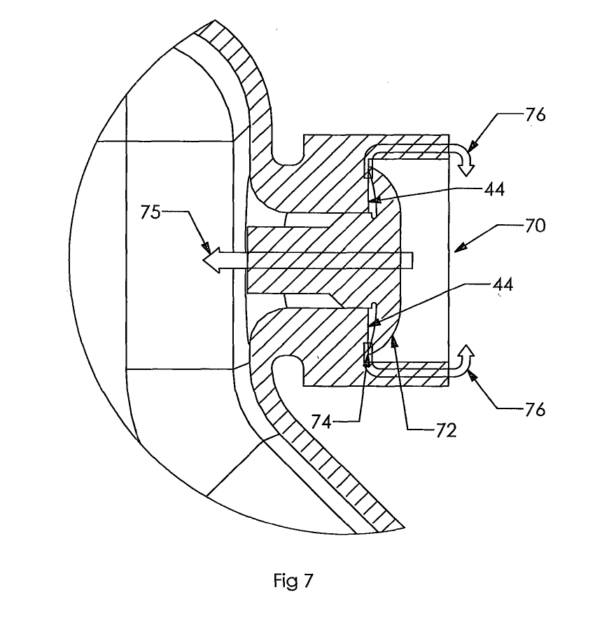

An alternative gas port embodiment is shown in FIG. 7. The valve body and clamp ring of FIG. 5 are replaced in this embodiment by a duckbill-umbrella combination valve body 70. Instead of a flange 34 at its outer end, the valve body defines an umbrella valve seal 72. The duckbill portion of the valve operates in a similar manner to the equivalent valve in the embodiments described above, allowing air to flow into the chamber along flow path 75.

In its closed position, the circumferential rim 74 of the umbrella valve forms a seal against the transversely extending surface 44. A hole or air passage 78 extends from the inner chamber of the cartridge at one end 80 to the exterior of the cartridge body 4 at its other end 82. The other end 82 forms a port in the surface 44. A fluid path from the end 82 to the surrounding atmosphere is closed by the seal formed by the rim 74 of the umbrella valve.

The umbrella valve provides a pressure relief means. This allows excess internal pressure within the chamber to be vented to its surroundings. An increase in the pressure within the chamber could occur for example if the cartridge experiences a temperature increase during operation. This may be as a result of an increase in the ambient temperature for example.

The escaping air flows through hole 78 in the direction of arrow 84 and then opens the umbrella valve to allow the air past the circular periphery of the umbrella valve along flow path 76 shown schematically in FIG. 7.

The umbrella valve may be configured to open when the pressure within the chamber exceeds the external ambient pressure by more than 200 mBar (2,000 Pa), for example.

The umbrella valve is configured to ensure that the pressure inside the chamber remains substantially the same as that of the surrounding atmosphere during operation. This ensures that the amount of liquid drawn from the chamber is independent of changes in the ambient temperature. This assists the printer in controlling the ink viscosity accurately. Otherwise, a temperature increase leading to a pressure increase within the cartridge, results in excess ink being dispensed, requiring the printer to add significant volumes of additional solvent to the ink to maintain the desired viscosity.

1. A container for storing and dispensing a liquid, comprising:
a chamber for holding a liquid, the chamber being defined by rigid chamber walls;
a liquid outlet port for dispensing the liquid from the chamber; and
a gas port configured to allow air into the chamber from the atmosphere outside the chamber only when the pressure outside the chamber exceeds the pressure inside the chamber by more than a predetermined threshold;
wherein the gas port is further configured to allow gas to flow out of the chamber when the pressure within the chamber exceeds the pressure of the atmosphere outside the chamber by more than a predetermined threshold.

2. A container of claim 1, wherein the gas port comprises a non-return valve having a valve body.

3. A container of claim 2, wherein the valve body is formed of an EPDM rubber material or a perfluoroelastomer material.

4. A container of claim 2, wherein the non-return valve is a duckbill valve.

5. A container of claim 2, wherein the valve body is mounted in an opening within the gas port and is able to define a fluid path between the outside and the inside of the chamber, wherein the fluid path is closed by the valve when the valve is closed.

6. A container of claim 5, wherein the opening is defined by a wall of the chamber.

7. A container of claim 5, wherein the valve includes a flange which extends outwardly from the valve body, over an outer surface surrounding the opening, and the gas port includes a clamp ring which axially compresses at least a portion of the flange against the outer surrounding surface.

8. A container of claim 7, wherein the clamp ring is configured so as to define the extent to which the flange is compressed.

9. A container of claim 8, wherein the gas port includes a clamp ring having a projection which is received by the valve body and radially outwardly compresses at least a portion of the valve body against an inner wall of the opening.

10. A container of claim 9, wherein the radial compression is greater than the axial compression.

11. A container of claim 9, wherein the radial compression is in the range of 18 to 30%.

12. A container of claim 9, wherein the axial compression is in the range of 5 to 10%.

13. A container of claim 1, wherein the gas port is configured to allow air into the chamber from the atmosphere outside the chamber when the pressure within the chamber falls below the pressure of the atmosphere outside the chamber by about 30 mBar (3,000 Pa) or more.

14. (canceled)

15. A container of claim 1, wherein the gas port is configured to allow gas to flow out of the chamber when the pressure within the chamber exceeds the pressure of the atmosphere outside the chamber by more than 200 mBar (2,000 Pa).

16. A container of claim 1, wherein the gas port includes a pressure relief valve.

17. A container of claim 16, wherein the gas port comprises a non-return valve having a valve body, and wherein the pressure relief valve has a valve body and the non-return valve body is integrally formed with the pressure relief valve body.

18. A container of claim 16, wherein the pressure relief valve is an umbrella valve.

19. A container of claim 1, including a removable cover for closing the gas port.

20. A container of claim 1, for storing and dispensing ink or solvent for use in a printer.

21. A container of claim 1, wherein the chamber is formed using a blow-moulding process.

22. (canceled)

23. A computer-readable medium storing computer-executable instructions adapted to cause a 3D printer to print a container of claim 1.
